(19) United States
(12) Patent Application Publication
(10) Pub. No.: US 2009/0040025 A1
(43) Pub. Date: Feb. 12, 2009

(54) Radio Frequency Identification Interrogation Systems and Methods of Operating The Same

(76) Inventors: John P. Volpi, Garland, TX (US); Steven D. Roemerman, Highland Village, TX (US); Joseph Edward Tepera, Muenster, TX (US); Logan Scott, Breckenridge, CO (US)

Correspondence Address: SLATER & MATSIL, L.L.P., 17950 PRESTON RD, SUITE 1000, DALLAS, TX, 75252-5793, US

(21) Appl. No.: 12/248,752

(22) Filed: Oct. 9, 2008

Related U.S. Application Data
(63) Continuation of application No. 11/090,334, filed on Mar. 25, 2005.
(60) Provisional application No. 60/556,582, filed on Mar. 26, 2004.

(51) Int. Cl. H04Q 5/22

(52) U.S. Cl. 340/10.1

(57) ABSTRACT

A reply code for a radio frequency identification (RFID) tag, a method of improving a reply code for a radio frequency identification (RFID) tag for interrogation by an interrogator and an RFID tag employing the same. In one embodiment, the reply code includes a preamble having information about a quality of a clock associated with the RFID tag. The reply code also includes a tag identification (ID) code providing a digital signature for the RFID tag. The reply code still further includes an aftamble located aft of the preamble and having information about the quality of the clock. The aftamble cooperates with the preamble to improve a quality of the reply code for interrogation by an interrogator.

This application is a continuation of U.S. patent application Ser. No. 11/090,334, entitled “Radio Frequency Identification Interrogation Systems and Methods of Operating the Same,” filed on Mar. 25, 2005, which claims the benefit of U.S. Provisional Application No. 60/556,582, entitled “RFID Omnibus,” filed on Mar. 26, 2004, both of which are incorporated herein by reference.

### TECHNICAL FIELD

The present invention is directed, in general, to communication systems and, more specifically, to radio frequency identification (RFID) interrogation systems and methods of operating the same.

### BACKGROUND

Asset tracking for the purposes of inventory control or the like is employed in a multitude of industry sectors such as in the food industry, apparel markets and any number of manufacturing sectors, to name a few. In many instances, a bar coded tag or radio frequency identification (RFID) tag is affixed to the asset and a reader interrogates the item to read the tag and ultimately to account for the asset being tracked. Although not readily adopted, RFID systems may be employed on a more granular level to track RFID objects (items with an RFID tag) at the unit level as opposed at the pallet level. Additionally, RFID systems may be employed in security and military applications to track RFID objects including people with RFID tags affixed thereto.

As mentioned above, there is a widespread practice in other fields for counting, tracking and accounting for items and two of the more prevalent and lowest cost approaches involve various types of bar coding and RFID techniques. As with bar coding, the RFID techniques are primarily used for automatic data capture and, to date, the technologies are generally not compatible with the counting of RFID objects at the unit level. A reason for the incompatibility in the supply chain field for the bar coding and RFID techniques is a prerequisite to identify items in noisy environments.

Even in view of the foregoing limitations for the application of RFID techniques in less than ideal conditions, RFID tags have been compatible with a number of arduous environments. In the pharmaceutical industry, for instance, RFID tags have survived manufacturing processes that require products to be sterilized for a period of time over 120 degrees Celsius. Products are autoclaved while mounted on steel racks tagged with an RFID tag such that a rack identification (ID) number and time/date stamp can be automatically collected at the beginning and end of the process as the rack travels through the autoclave on a conveyor. The RFID tags can be specified to withstand more than 1000 hours at temperatures above 120 degrees Celsius.

While identification tags or labels may be able to survive the difficult conditions associated with medical applications, there is yet another challenge directed to attaching an identification element to any small device. The RFID tags are frequently attached to devices by employing mechanical techniques or may be affixed with sewing techniques. A more common form of attachment of an RFID tag to a device is by bonding techniques including encapsulation or adhesion.

While manufacturers have multiple options for bonding, critical disparities between materials may exist in areas such as biocompatibility, bond strength, curing characteristics, flexibility and gap-filling capabilities. A number of bonding materials are used in the assembly and fabrication of both disposable and reusable medical devices, many of which are certified to United States Pharmacopoeia Class VI requirements. These products include epoxies, silicones, ultraviolet curables, cyanoacrylates, and special acrylic polymer formulations.

As previously mentioned, familiar applications for RFID techniques include “smart labels” in airline baggage tracking and in many stores for inventory control and for theft deterrence. In some cases, the smart labels may combine both RFID and bar coding techniques. The tags may include batteries and typically only function as read only devices or as read/write devices. Less familiar applications for RFID techniques include the inclusion of RFID tags in automobile key fobs as anti-theft devices, identification badges for employees, and RFID tags incorporated into a wrist band as an accurate and secure method of identifying and tracking prison inmates and patrons at entertainment and recreation facilities. Within the medical field, RFID tags have been proposed for tracking patients and patient files, employee identification badges, identification of blood bags, and process management within the factories of manufacturers making products for medical practice.

Typically, RFID tags without batteries (i.e., passive devices) are smaller, lighter and less expensive than those that are active devices. The passive RFID tags are typically maintenance free and can last for long periods of time. The passive RFID tags are relatively inexpensive, generally as small as an inch in length, and about an eighth of an inch in diameter when encapsulated in hermetic glass cylinders. Recent developments indicate that they will soon be even smaller. The RFID tags can be encoded with 64 or more bits of data that represent a large number of unique ID numbers (e.g., about 18,446,744,073,709,551,616 unique ID numbers). Obviously, this number of encoded data provides more than enough unique codes to identify every item used in a surgical procedure or in other environments that may benefit from asset tracking.

An important attribute of RFID interrogation systems is that a number of RFID tags should be interrogated simultaneously stemming from the signal processing associated with the techniques of impressing the identification information on the carrier signal. A related and desirable attribute is that there is not typically a minimum separation required between the RFID tags. Using an anti-collision algorithm, multiple RFID tags may be readily identifiable and, even at an extreme reading range, only minimal separation (e.g., five centimeters or less) to prevent mutual de-tuning is generally necessary. Most other identification systems, such as systems employing bar codes, usually impose that each device be interrogated separately. The ability to interrogate a plurality of closely spaced RFID tags simultaneously is desirable for applications requiring rapid interrogation of a large number of items.

In general, the sector of radio frequency identification is one of the fastest growing areas within the field of automatic identification and data collection. A reason for the proliferation of RFID systems is that RFID tags may be affixed to a variety of diverse objects (also referred to as “RFID objects”) and a presence of the RFID tags may be detected without actually physically viewing or contacting the RFID tag. As a result, multiple applications have been developed for the RFID systems and more are being developed every day.

The parameters for the applications of the RFID systems vary widely, but can generally be divided into three significant categories. First, an ability to read the RFID tags rapidly. Another category revolves around an ability to read a significant number of the RFID tags simultaneously (or nearly simultaneously). A third category stems from an ability to read the RFID tags reliably at increased ranges or under conditions wherein the radio frequency signals have been substantially attenuated. While significant progress has been made in the area of reading multiple RFID tags almost simultaneously (see, for instance, U.S. Pat. No. 6,265,962 entitled “Method for Resolving Signal Collisions Between Multiple RFID Transponders in a Field,” to Black, et al., issued Jul. 24, 2001, which is incorporated herein by reference), there is still room for significant improvement in the area of reading the RFID tags reliably at increased ranges or under conditions when the radio frequency signals have been substantially attenuated.

Accordingly, what is needed in the art is radio frequency identification interrogation systems and related methods to identify and account for all types of items regardless of the environment or application that overcomes the deficiencies of the prior art. Additionally, what is needed in the art is radio frequency identification interrogation system that provides a location of a radio frequency identification object. Also what is needed in the art is radio frequency identification tags that facilitate higher sensitivity reading and exhibit characteristics that protect the integrity of the information associated therewith.

### SUMMARY OF THE INVENTION

These and other problems are generally solved or circumvented, and technical advantages are generally achieved, by advantageous embodiments of the present invention which includes a reply code for a radio frequency identification (RFID) tag, a method of improving a reply code for a radio frequency identification (RFID) tag for interrogation by an interrogator and an RFID tag employing the same. In one embodiment, the reply code includes a preamble having information about a quality of a clock associated with the RFID tag. The reply code also includes a tag identification (ID) code providing a digital signature for the RFID tag. The reply code still further includes an aftamble located aft of the preamble and having information about the quality of the clock. The aftamble cooperates with the preamble to improve a quality of the reply code for interrogation by an interrogator.

In another aspect, the present invention provides an RFID tag, and a method of operating the same. In one embodiment, the RFID tag includes a substrate. The RFID tag also includes a non-electrical destruction mechanism coupled to the substrate and configured to render the RFID tag inoperative upon an occurrence of an event.

In another aspect, the present invention provides an RFID interrogation system, and a method of operating the same. In one embodiment, the RFID interrogation system includes an interrogator configured to energize an RFID tag on an RFID object via a beam emanating from an antenna coupled thereto. The RFID interrogation system also includes a camera, aligned with a boresight of the antenna, configured to provide a view of the RFID object.

In another aspect, the present invention provides an RFID interrogation system, and a method of operating the same. In one embodiment, the RFID interrogation system includes first and second antennas configured to create first and second communication channels, respectively. The RFID interrogation system also includes a first receiver section configured to sense a radio frequency signal from the first communication channel, a second receiver section configured to sense a radio frequency signal from the second communication channel. The RFID interrogation system still further includes a controller configured to employ the radio frequency signals from the first and second communication channels to derive an improved signal representing a reply code to ascertain a presence of an RFID object.

In another aspect, the present invention provides an RFID interrogation system having a platform, and a method of operating the same. In one embodiment, the RFID interrogation system includes an interrogator located on the platform and configured to receive responses from an RFID tag. The RFID interrogation system also includes a navigation system located on the platform and configured to provide time and positioning information of the platform in response to detection of the RFID tag. The RFID interrogation system still further includes a synthetic aperture radar (SAR) processor configured to construct a signal from a synthetic aperture derived from the responses from the RFID tag, and the time and positioning information.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a diagram of an embodiment of an RFID interrogation system constructed in accordance with the principles of the present invention,

FIG. 2 illustrates a block diagram of an embodiment of a reply code from an RFID tag in response to a query by an interrogator constructed in accordance with the principles of the present invention,

FIG. 3 illustrates a waveform diagram of an exemplary one-bit cell of a response from an RFID tag to an interrogator in accordance with the principles of the present invention,

FIG. 4 illustrates a block diagram of an embodiment of a reply code from an RFID tag in response to a query by an interrogator constructed in accordance with the principles of the present invention,

FIG. 5 illustrates a diagram of an embodiment of an RFID interrogation system constructed in accordance with the principles of the present invention,

FIG. 6 illustrates a diagram of an embodiment of an RFID interrogation system constructed in accordance with the principles of the present invention,

FIGS. 7 to 9 illustrate block diagrams of alternative embodiments of RFID tags constructed in accordance with the principles of the present invention,

FIG. 10 illustrated is an embodiment of an RFID interrogation system constructed in accordance with the principles of the present invention, and

FIG. 11 illustrates a diagram demonstrating advantages associated with the embodiment of the RFID interrogation system of FIG. 10.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to exemplary embodiments in a specific context, namely, RFID interrogation systems and methods of operating the same.

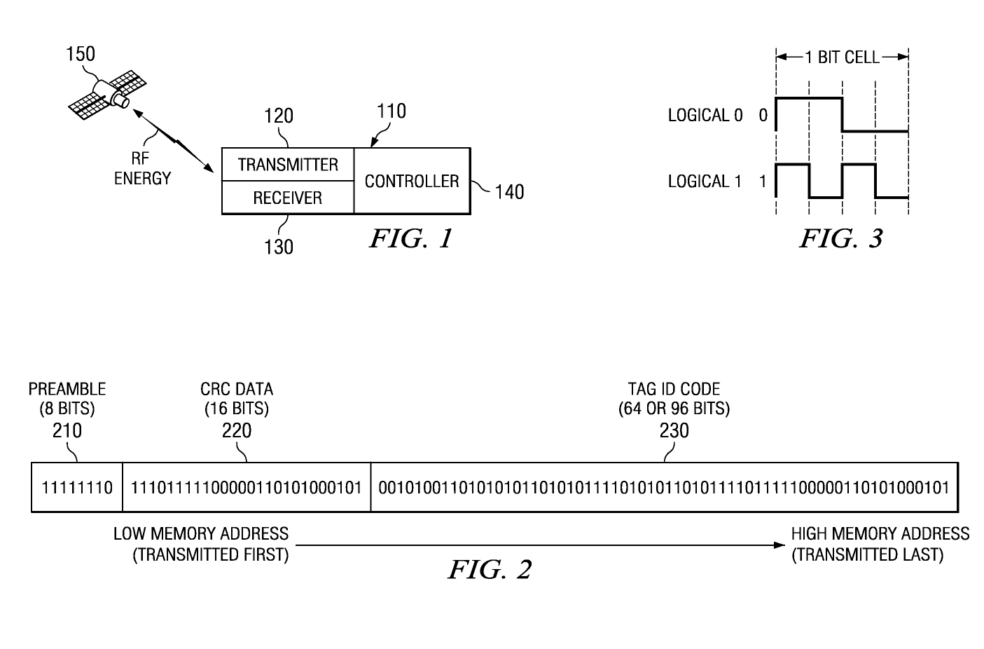

Referring initially to FIG. 1, illustrated is a diagram of an embodiment of an RFID interrogation system constructed in accordance with the principles of the present. The RFID interrogation system includes an interrogator 110 with a transmitter 120, a receiver 130, and a controller 140. The interrogator 110 energizes an RFID tag 150 and then receives the encoded radio frequency (RF) energy (reflected or transmitted) from the RFID tag 150, which is detected and decoded by the receiver 130. The controller 140 provides overall control of the interrogator as well as providing reporting functions. Additionally, the interrogator typically includes a data input/output port, keyboard, display, power conditioner, power source, battery, antennas, and a housing. An example of an interrogator is provided in U.S. Pat. No. 7,019,650 entitled “Interrogator and Interrogation System Employing the Same,” to Volpi, et al., issued Mar. 28, 2006, which is incorporated herein by reference.

Additionally, the RFID interrogation system may be employed with multiple RFID objects and with different types of RFID tags. For example, the RFID tags may be passive, passive with active response, and fully active. For a passive RFID tag, the transmitted energy provides a source to charge an energy storage device within the RFID tag. The stored energy is used to power a response from the RFID tag wherein a matching impedance and thereby a reflectivity of the RFID tag is altered in a coded fashion of ones (“1”) and zeros (“0”). At times, the RFID tag will also contain a battery to facilitate a response therefrom. The battery can simply be used to provide power for the impedance matching/mismatching operation described above, or the RFID tag may even possess an active transmitting function and may even respond at a frequency different from a frequency of the interrogator. Any type of tag (e.g., RFID tag) whether presently available or developed in the future may be employed in conjunction with the RFID interrogation system. Additionally, the RFID objects (i.e., an object with an RFID tag) may include more than one RFID tag, each carrying different information (e.g., object specific or sensors reporting on the status of the object) about the RFID object. The RFID tags may also include more than one integrated circuit, each circuit including different coded information for a benefit of the interrogation system. For an example of a passive RFID tag, see U.S. Pat. No. 6,859,190 entitled “RFID Tag with a Quadrupler or N-Tupler Circuit for Efficient RF to DC Conversion,” to Pillai, et al., issued on Feb. 22, 2005, and U.S. Pat. No. 6,618,024 entitled “Holographic Label with a Radio Frequency Transponder,” by Adair, et al., issued Sep. 9, 2003, which are incorporated herein by reference. Of course, other types of RFID tags including surface acoustic wave identification tags such as disclosed in U.S. Patent Application Publication No. 2003/0111540 entitled “Surface Acoustic Wave Identification Tag having Enhanced Data Content and Methods of Operation and Manufacture Thereof,” to Hartmann, published Jun. 19, 2003, which is incorporated herein by reference, may be employed in conjunction with the principles of the present invention.

Turning now to FIG. 2, illustrated is a block diagram of an embodiment of a reply code from an RFID tag in response to a query by an interrogator constructed according to the principles of the present invention. In the present embodiment, the reply code includes three sections, namely, a preamble 210, a cyclic redundancy check (CRC) field 220 to check for bit errors, and a tag identification (ID) code 230 that uniquely specifies an RFID tag. In this example, the preamble 210 is a fixed length having eight bits, the CRC field 220 is 16 bits and the tag ID code 230 is either 64 or 96 bits. Of course, the length of the respective sections of the reply code and the sections that form the reply code may be modified including the addition of additional or different sections and still fall within the broad scope of the present invention. The bits of the reply code are generated sequentially or serially at a rate determined by an oscillator acting like a clock within the RFID tag. The frequency of the oscillator is synchronized to a clock of an interrogator during the initial interrogation by the interrogator.

The interrogator may employ the tag ID code 230 to more definitively detect and identify a specific RFID tag and a digital signature associated with the RFID tag. More specifically, it is possible to detect an RFID tag employing portions of or the entirety of the reply code. As an example, the interrogator may employ the tag ID code 230 only to detect a presence of an RFID tag or employ the additional bits available from the CRC field 220 as well as the preamble 210 or other sections of the reply code to create a longer and more sensitive data stream for processing and identifying an RFID tag. Also, in a conventional reader mode and as noted above, the RFID tags may be detected via incoming RF energy and without apriori knowledge of any information about the RFID tag. In this instance, a relatively strong signal incident on the interrogator is preferable to generate a sufficiently positive signal to noise ratio (SNR) to reliably detect the incoming signal and, ultimately, the presence of the RFID tag.

Turning now to FIG. 3, illustrated is a waveform diagram of an exemplary one-bit cell of a response from an RFID tag to an interrogator in accordance with the principles of the present invention. With a logical “1” response, zero encoding is in a frequency shift keying (FSK) modulation format to distinguish logical “1” from logical “0,” but an on/off nature of the backscatter return signal of the RFID tag is also actually an amplitude shift keying (ASK) signal. The shift in amplitude is detected by the interrogator and the frequency of operation determines whether the detection represents a logical “1” or logical “0.” For a better understanding of RFID tags, see “Technical Report 860 MHz-930 MHz Class I Radio Frequency Identification Tag Radio Frequency & Logical Communication Interface Specification Candidate Recommendation,” Version 1.0.1, November 2002, promulgated by the Auto-ID Center, Massachusetts Institute of Technology, 77 Massachusetts Avenue, Bldg 3-449, Cambridge Mass. 02139-4307, which is incorporated herein by reference.

The backscatter return signal is embodied in the response from an RFID tag. A low backscatter return signal is generated when the RFID tag provides a matched load so that any energy incident on the antenna of the RFID tag is dissipated within the RFID tag and therefore not returned to the interrogator. Alternatively, a high backscatter return signal is generated when the RFID tag provides a mismatched load so that any energy incident on the antenna of the RFID tag is reflected from the RFID tag and therefore returned to the interrogator. For more information, see “RFID Handbook,” by Klaus Finkenzeller, published by John Wiley & Sons, Ltd., 2^{nd} edition (2003), which is incorporated herein by reference.

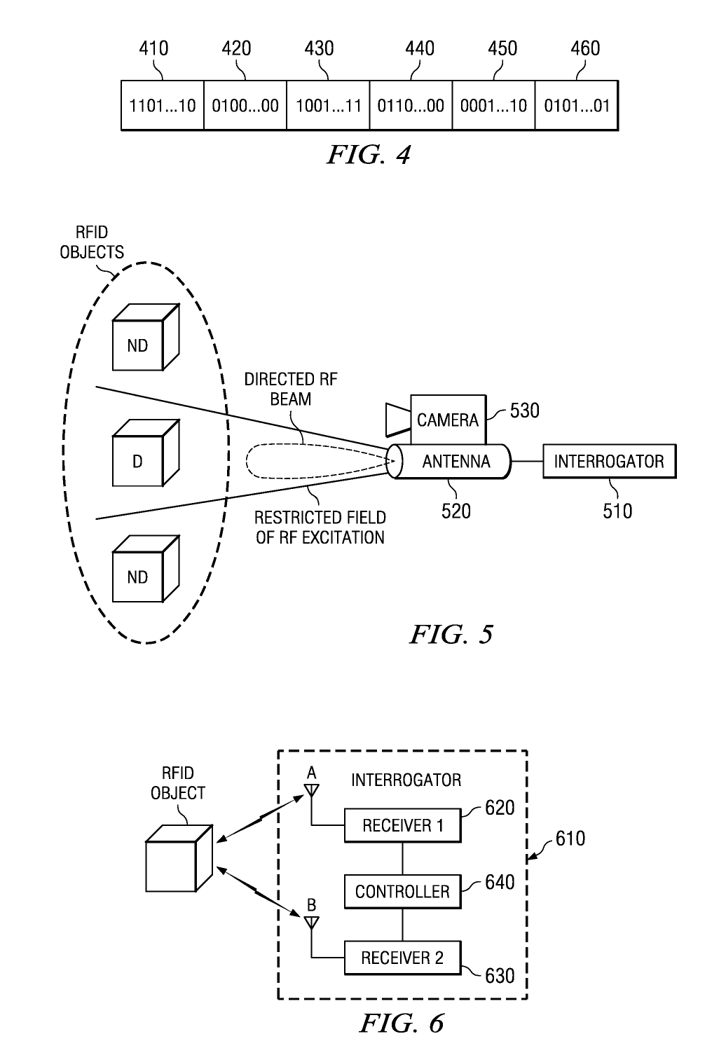

Turning now to FIG. 4, illustrated is a block diagram of an embodiment of a reply code from an RFID tag in response to a query by an interrogator constructed according to the principles of the present invention. The reply code includes a preamble 410 located at a fore end of the reply code, a CRC field 420, a first tag ID code section 430, an aftamble (e.g., a midamble) 440, a second tag ID code section 450 and another aftamble (e.g., a postamble) 460. For the purposes herein, the term “aftamble” is located later in the bit stream after the preamble. The additional sections of the reply code such as the midamble 440 and the postamble 460 assist in establishing signal synchronization as well as signal identification or identification type. The tag ID code is divided into at least two sections with the midamble 440 located in a middle section of the reply code inserted therebetween. The tag ID code includes information that more definitively allows for the detection and identification of a specific RFID tag and a digital signature associated with the RFID tag. Finally, the postamble 460 is aft of the midamble 440 and forms the tail end of the reply code.

With their location within the reply code, as opposed to only a preamble at the beginning, the midamble 440 and the postamble 460 are able to resynchronize the reply code or provide additional information as to the health or stability of the communication channel (e.g., fading) accommodating the reply code. The midamble 440 and postamble 460 also allow for longer codes to be reliably read and detected or tolerate poorer oscillator performance with respect to, for instance, synchronization and drift. The preamble 410, midamble 440 and postamble 460 can be used to derive information about a quality of a clock associated with the RFID tag. The midamble 440 and postamble 460 cooperating with the preamble 410 provides information to derive clock bias and drift rate more accurately than a preamble 410 by itself, especially with longer reply codes. The midamble 440 and postamble 460 cooperate with the preamble 410 to allow the interrogator to correct for clock bias and drift to improve the bit error rate of the reply code and the sensitivity of the interrogator.

An interrogator may employ a correlating receiver to initially correlate on portions of the reply code such as the midamble 440 thereby using that information to gain additional timing integrity with regard to the incoming bit stream including the reply code over a communication channel. The additional timing integrity may then be used to practically allow longer integration times for the correlating receiver. As a result, effective longer integration times will directly contribute to better signal to noise ratios without increasing false alarm rates and augment the detection properties of the interrogator. The aforementioned reply code will be advantageous as longer tag ID codes and, generally, reply codes are adopted, reading ranges are extended, and reading rates under less than ideal conditions are increased.

The role of the midamble 440 and postamble 460 may be extended beyond providing single fixed codes for the RFID tags. For instance, the midamble 440 and postamble 460 may also convey information as to identifying classes or subclasses of RFID tags and therefore the objects to which they are attached. In this manner, the RFID tags may then be commanded to a quiet mode wherein such RFID tags will not contribute to responses or the response from the RFID tags may be included or rejected outright in the integration function of the correlating receiver of the interrogator.

As mentioned above, the midamble 440 or postamble 460 provide enhanced timing information associated with reply code to better enable coherent integration in addition to or instead of non-coherent integration. Coherent integration is performed prior to correlation and has the advantage of increasing the received signal to noise ratio directly as ‘N’ where N is the number of samples integrated. This is in contrast to non-coherent integration which increases the received signal to noise ratio as the square root of N. Coherent integration, when possible, is preferable but is often difficult to implement due to a lack of timing information to be effectively implemented. The use of the midamble 440 or the postambles 460 facilitates coherent integration due to the better timing information provided with the reply code.

It is also possible to look for specific code segments or fragments at known locations within the tag ID code(s). For example, if it is known that the first K bits of a tag ID code is dedicated to a specific manufacturer, then out of a group of RFID tags, only those RFID tags corresponding to that specific manufacturer could be quickly identified. Alternatively, there are many other specific code segments or fragments corresponding to, but not limited to, elements such as product type, date of manufacture, country of origin or any other useful information. The correlating receiver can correlate on specific segments of the reply code and quickly provide useful information to any query so directed.

Alternatively, the interrogator may specifically look for segments or fragments as discussed above, but then to use that information to reject such RFID tags. An example might be to look for items of a specific product that were NOT made by a particular manufacturer. Other similar examples include, but are not limited to, elements such as: product type, date of manufacture, country of origin or any other useful item of information. Those skilled in the art will readily see from these examples that a number of population sorting methods can be achieved to achieve a wide range of desired outcomes. A number of problems related to poor signal to noise ratios, large populations of RFID tags to be read, sorting of the RFID tags, and other similar problems can be addressed by these methods.

The correlation of reply codes in the context of RFID interrogation systems as disclosed in U.S. Patent Application Publication No. 2005/0201450, entitled “Interrogator and Interrogation System Employing the Same,” to Volpi, et al., published Sep. 15, 2005, which is incorporated herein by reference, teaches about substantially improving receiver sensitivity when employing correlation techniques and spread spectrum techniques to detect RFID tags. Those techniques are principally directed to increasing the sensitivity of the interrogator and do not specifically address improving the sensitivity of the RFID tag's ability to detect a command therefrom.

For instance, consider an RFID tag that includes a system for receiving a command enhanced by correlation and spread spectrum techniques. In one embodiment, the RFID tag includes a correlation subsystem dedicated to each relevant command from an interrogator. Whenever the interrogator sent that command, that RFID tag's ability to detect and thereby respond would be significantly enhanced. The number of commands detected in this manner varies with the application and type of RFID tag. This feature does not change any of the standard commands used for querying an RFID tag and comprehends using and detecting commands as defined by the specifications for that class of RFID tag.

Alternatively, a series of new commands may serve as queries from the interrogator. The commands or queries may have the unique properties of being from a set of orthogonal codes such as, without limitation, families or sequences of codes from Walsh-Hadamard, Gold, ML and Kasami codes. Each code has specific properties, but all share the same property of orthogonality so that the cross correlation function between any two codes within a family is very low. This greatly reduces the likelihood that a specific command detected by the correlating RFID tag will be erroneously interpreted as being a different command. Another embodiment is to consider a specific interrogator command as a key. This is useful for high value or security applications. As an example, responses to subsequent queries are only responded to by the interrogator and the RFID tag once an initial key is used and acknowledged.

Additionally, enhanced security can be achieved by configuring the RFID tags to respond when at least two different interrogators each present a unique query within a specified time or order with respect to each other. In another embodiment, the interrogators may both provide a simultaneous query. The aforementioned RFID interrogation systems are valid for standard RFID tag decoding as well as for correlating RFID tag decoding. They may also be used with active RFID tags wherein the RFID tag's responses can be at different bands and of more complex response types. These embodiments are particularly useful for high value objects or for security applications such as, without limitation, shipping high value cargo and for unique identification in counter-terrorism applications.

As mentioned above, for a correlating receiver the RFID reply code can be generated using sequences from orthogonal codes such as, without limitation, Walsh-Hadamard, ML, Gold, and Kasami codes. The tag ID codes generated using these sequences will in general have good cross correlation characteristics.

Of course, “off-the-shelf” codes from standard RFID tags may be employed to advantage as well. The “standard RFID tags” might include the data represented in a standard bit pattern of an electronic product code (EPC) RFID tag, or any other data load which complies with a pre-determined set of rules. In conjunction therewith, all of the data bits loaded in an RFID tag, or only a portion, such as the manufacturer's code may be employed to advantage. The cross correlation characteristics may not be as good, but the correlating receiver will still provide better results than a conventional receiver when employed to detect standard, non-orthogonal codes.

The use of standard tags allows significant improvements in many useful processes such as for the so called “x-ray reading” processes in which RFID objects (e.g., pallets loaded with several tagged cartons) are to be interrogated to detect the RFID tags thereon including the RFID tags embedded deep inside the stack of cartons. This process is also useful in medical and veterinarian applications, where RFID tags may be so deeply embedded in tissue, organic fluids, or other materials, that the link margin between the RFID tag and the interrogator is degraded. Those skilled in the art will readily see that the use of a correlating receiver with data content based on some a-priori standard, but not necessarily a pseudo noise (PN) code chosen for optimal signal processing considerations, has a very large number of useful applications, and represents a technique to improve a large number of processes in a number of fields such as, without limitation, logistics, material handling, process control, medical, veterinary, and military applications.

Turning now to FIG. 5, illustrated is a diagram of an embodiment of an RFID interrogation system constructed in accordance with the principles of the present invention. Often it is important to not only detect a response to a query from an interrogator 510, but also to establish the location of the RFID object. The RFID interrogation system of the illustrated embodiment addresses the aforementioned challenge by devising a system including an antenna (e.g., a directive antenna) 520 with a directed RF beam and a camera 530 aligned with a boresight of the antenna 520. The RF beam energizes the RFID tags associated with RF objects within a narrow angular field of view that is also covered by the camera 530. For purposes of illustration, the camera 530 is mounted on an antenna assembly. Those skilled in the art will be familiar with the so-called “Pringles Can” class of antenna, and will readily see that a number of co-axial embodiments of this invention are practical, and for some applications very desirable.

Since the size of practical antennas and optics is relatively small, the integrated aperture (i.e., beam from the antenna of the interrogator and the camera) can be concealed in any number of objects, such as store displays, trash containers, doorframes, and other items. This allows for a very discreet method of operation. The RFID objects respond within the illustrated field of view and are captured by the camera. As an example, the type of camera 530 may be, without limitation, a digital still, video, or film camera. The RFID interrogation system will establish a field in which the RFID object can be viewed, although it may not establish a specific position thereof. The RFID interrogation system of the instant embodiment may be applied to a wide number of purposes and processes including, but not limited to, security, surveillance, theft prevention, asset recovery, customer in-store behavior pattern measurements, stock location, and time and motion studies.

Turning now to FIG. 6, illustrated is a diagram of an embodiment of an RFID interrogation system constructed in accordance with the principles of the present invention. Multipath is often present in environments when the sensing of RFID tags of RFID objects is desired. This can cause data to be erratic due to the vector summing of the incoming RF signals. To alleviate the issue of erratic incoming signals due to large multipath, a solution involves employing an RFID interrogation system with two independent communication channels created by antenna characteristics associated with the RFID interrogation system. The aforementioned channels have substantially the same frequency, modulation, and time characteristics, but differ in spatial location of the antenna or polarization of the antenna. In one embodiment, each communication channel includes an interrogator. Alternatively, a common transmitter is used and only the receivers of the interrogator are independent. An important attribute of such an RFID interrogation system is an orthogonal RF technique for the receiver or the transmitter. For example, this can be achieved by employing antennas of different polarization (e.g., horizontal and vertical) or by separating the antennas by at least five and preferably ten wavelengths. Of course, other techniques to achieve RF orthogonality are well within the broad scope of the present invention.

In the instant embodiment, an interrogator 610 includes first and second receivers 620, 630 for sensing radio frequency signals from first and second communication channels, respectively, and a transmitter (not shown). The interrogator 610 also includes a controller 640 that synchronizes an operation of the first and second receiver sections 620, 630 coupled to separate communication channels and also integrates the results of each individual channel. For the integration function, it is possible to choose the greater signal between the first and second receiver sections 620, 630 or use adaptive ratio weighting wherein the energy of the radio frequency signals from the first and second receiver sections 620, 630 is added into a single value with each input weighted according to factors such as a quality factor. For example, because of orthogonality, the probability that both RFID channels will experience deep fade simultaneously is much smaller than the probability that either one will be in deep fade. Thus, a continuous stream of acceptable input signals due to a query is much more likely. This facilitates the ability to integrate multiple RFID tag responses for added sensitivity. Thus, the controller 640 employs radio frequency signals from the first and second communication channels to derive an improved signal representing a reply code to ascertain a presence of an RFID object.

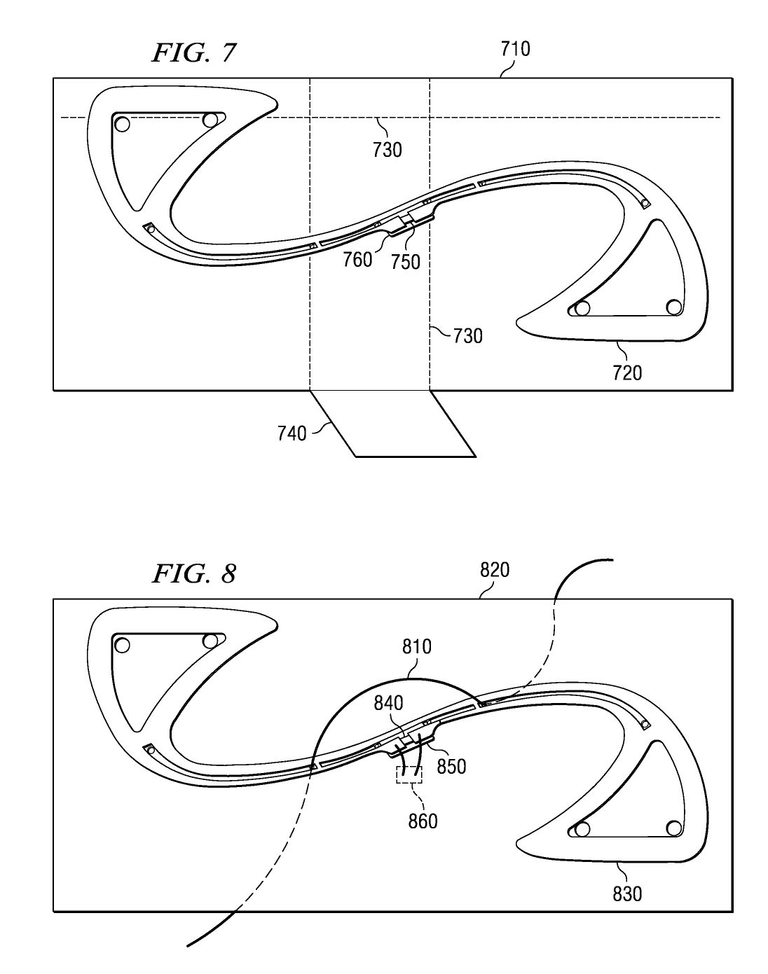

Turning now to FIGS. 7 to 9, illustrated are block diagrams of alternative embodiments of RFID tags constructed in accordance with the principles of the present invention. RFID tags can, in some circumstances, become unwanted, or even a hazard. In these situations, it is desirable to have a technique to ensure that the RFID tag cannot function. For instance, the electronic product code (EPC) standards provide a “kill” function in which an RFID tag can be instructed to never respond again to any inquiries. To invoke this “kill” function, an interrogator may instruct the RFID tag to not respond.

There are many cases, however, when the kill function is not adequate, or is impractical. For example, in the case of the RFID tagging of ordnance, with one purpose being to find unexploded ordnance (UXO), there is no way to know a priori which RFID objects will operate properly, and which will be “duds” and thereby become UXO. It is desirable in this sort of circumstance to know that most or all of the RFID tags which are no longer of interest (such as those which had been attached to munitions that did function), do not function or respond to interrogation. Inasmuch as the RFID tags are very small, and are mechanically very strong, there is a possibility that the RFID tags will continue to function, even after the explosion of a bomb. So, it is of interest to devise a technique to disable the RFID tags that is simple, reliable, inexpensive, and which does not rely on a interrogator or the like to instruct the RFID tag to invoke a “kill” mode. Thus, the system of the present invention includes a structure for disabling the RFID tags by, for instance, destroying an integrity of an antenna thereof. The antenna is an important feature of the RFID tag and, therefore, provides a viable aspect to attack the validity thereof.

Referring now to FIG. 7, the RFID tag includes a substrate 710 on which an antenna 720 is located with perforations 730 (akin to consumer product packages) in the substrate 710. The conductive ink, deposited metal, or other conductor which composes the antenna 720 is arranged on the substrate 710 in such a way that the perforations 730 do not interfere with the antenna 720. When mechanical stress is imposed on the RFID tag, it will tear along the perforations 730 (facilitating a tearing) and, as a result, the antenna 720 is compromised, thereby disabling the RFID tag.

A class of applications for the principles of the present invention is to provide consumers with system that assures privacy by the destruction of RFID tags. This is one of many applications wherein user controlled destruction might be desirable. Another example of an application of assured destruction, or assured privacy is the use of RFID tags in military applications, wherein there may be a concern that an enemy using an interrogator might find the RFID tag. In such cases, a “pull tab” 740 attached to the substrate 710 may be employed to disable or destroy the RFID tag by pulling the pull tab 740 away from the substrate 710. The RFID tag also includes an electronic circuit (e.g., an integrated circuit) 750 including a clock and a carrier 760 with an electrical connection therebetween. The carrier 760 is coupled to the substrate 710 by mechanical and electrical connectivity. As mentioned above, those skilled in the art understand that other types of RFID tags including RFID tags based on piezo-electric transducers are well within the broad scope of the present invention. Thus, the RFID tag includes a non-electrical destruction mechanism (e.g., at least the perforations 730 or the pull tab 740) coupled to the substrate and configured to render the RFID tag inoperative upon an occurrence of an event.

Referring now to FIG. 8, illustrated is an alternative embodiment of an RFID tag constructed according to the principles of the present invention. A small lanyard 810 made of a material that is of higher tensile strength than a substrate 820 is attached to the substrate 820 bearing the antenna 830. When mechanical stress is applied differentially to the RFID tag and the lanyard 810, the lanyard 810 will tear the substrate 820, in much the same way that a wire cheese slicer cuts through cheese or tears it apart. In the general case, the RFID tag is arranged so that when predetermined mechanical force is applied, the substrate 820 bearing the antenna 830 is subjected to mechanical failure and, as a result, the RFID tag's antenna 830 is destroyed. The substrate 820 may be formed from acetate, Mylar or other suitable dielectric substrate. The RFID tag also includes an electronic circuit (e.g., an integrated circuit) 840 including a clock and a carrier 850 with an electrical connection therebetween. The RFID tag also includes a sensor (e.g., a strain gauge) 860 as described below. Again, the RFID tag includes a non-electrical destruction mechanism (e.g., at least the lanyard 810) coupled to the substrate and configured to render the RFID tag inoperative upon an occurrence of an event.

In the case of a tagged submunition such as the BLU-97, an RFID tag might be applied to the ballute, which is the drogue intended to slow and stabilize the munition. These drogues are typically made of nylon or a similar woven material, and provide a good RF location for an RFID tag. However, the drogues often survive a BLU-97 explosion. Exemplary embodiments of such weapons are described in U.S. patent application Ser. No. 10/841,192 entitled “Weapon and Weapon System Employing the Same,” to Roemerman, et al., filed May 7, 2004, and U.S. patent application Ser. No. 10/997,617 entitled “Weapon and Weapon System Employing the Same,” to Tepara, et al., filed Nov. 24, 2004, which are incorporated herein by reference.

A method for destroying the electric continuity of the antenna 830 is to cause the substrate 820, the antenna 830 or a combination thereof to tear, separate or rip. A tearing, separation or ripping action can be achieved by integrating a high tensile strength lanyard or twisted thread constructed of a high tensile strength lanyard such as Kevlar or thread twisted from Kevlar filaments, into the antenna 830. The high tensile strength thread could be attached to slots, which already exist in the BLU-97 body. A Kevlar lanyard has a tensile strength in the range of 500,000 pounds-force per square inch. If a munition operates properly, the main body of the munition will be fragmented, and will be distributed by the blast of the explosion as shrapnel. The Kevlar lanyards have a higher tensile strength than most substrates made of materials such as Mylar. Mylar film has a tensile strength in the range of 30,000 pounds-force per square inch. When a lanyard is put in tension because of the movement of a fragment to which it is attached, the high tensile strength lanyard will pull on the substrate 820 introducing areas of high stress and stress concentrations causing the substrate 820 to tear, or antenna 830 to fracture and separate.

Inasmuch as the RFID tag is attached to the drogue, and because other lanyards will be pulling in other directions, the RFID tag is unable to accelerate in response to the force from the lanyard. As a result, the substrate 820 fails and the lanyard tears or cuts a path through it. If the lanyard has been properly placed, the path will cut through the antenna 830. The illustrated embodiment provides an arrangement that accommodates the aforementioned application and can take advantage of the lanyards to destroy the RFID tag. Of course, a wide range of applications can benefit from the design criteria as described with respect to the illustrate embodiment and other features, such as labels, are applicable herewith.

Another application associated with the RFID tags as described herein is to attach the RFID tag to items under warranty. If an article is returned for warranty work, and the RFID tag has been disabled because of unauthorized disassembly, then the warranty is void. A perforated RFID tag or an RFID tag with a lanyard may be configured in such a way that upon opening an item, the RFID tag will be mechanically compromised, and thereby electrically disabled. The RFID tag may accommodate both perforations and lanyard holes. Of course, one of the aforementioned features may be removed or replaced with yet other features to attain an analogous result. Additionally, the lanyard holes may be aligned with the perforations, and thereby serve both roles.

Yet another way to disable the tags is to alter the response characteristic of the circuit by incorporating an environmentally sensitive component or element on the substrate. The environmentally sensitive component, such as a thermocouple, thermister, acoustic sensor, pressure sensor, light sensor, acceleration sensor or selected combinations thereof, when exposed to predetermined environments, introduces into the circuit a signal in such a manner as to alter the circuit's response characteristics. One example is to incorporate a pressure sensitive or acceleration sensitive component, such as a piezo-electric crystal, into the circuit. When the pressure sensitive or acceleration sensitive component is exposed to the appropriate environmental conditions, a signal is introduced into the circuit in such a manner as to alter the circuit's response characteristic either by acting to disable, destroy, change the circuit's coding or combinations thereof. The interrogator will interpret the revised signal as that of an explosive unit that has been detonated.

Another embodiment employs a chemical destruction mechanism that may be seen in the example of a photoresistive element on the substrate, which changes the impedance match between the circuit and the antenna. At a sufficient illumination level, the interrogator signal no longer provides enough power to activate the circuit, and the RFID tag is rendered inoperative. Those skilled in the art will see that the addition of such environmental sensors can be arranged to either temporarily or permanently disable the RFID tag. As an example, elements of the RFID tag may be soluble in a liquid so that when exposed to liquid the RFID tag is disabled.

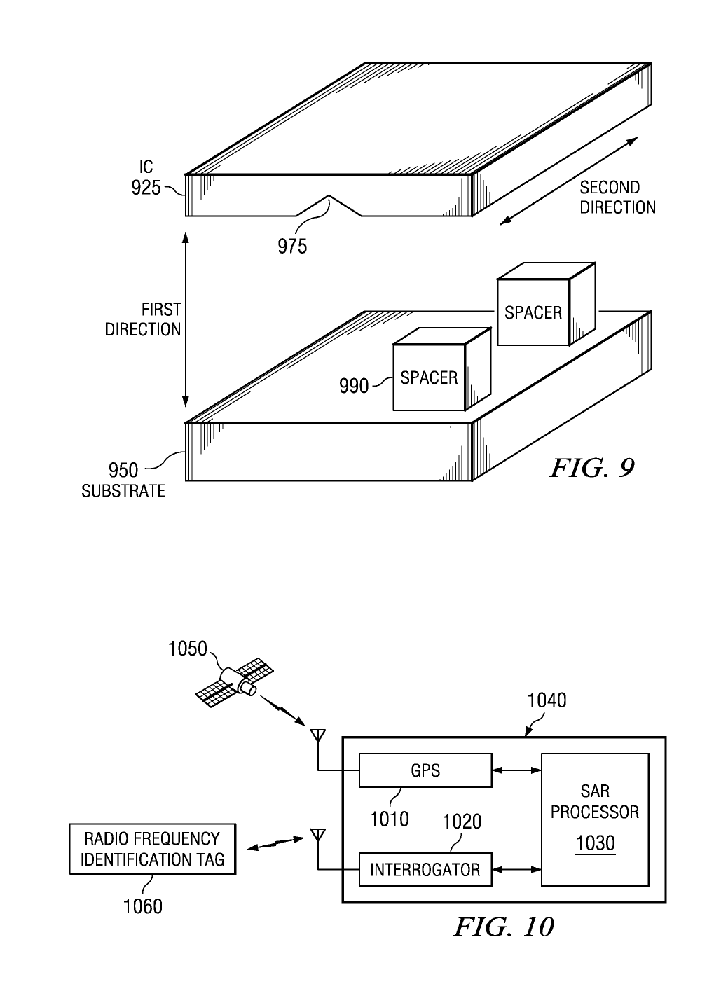

Referring now to FIG. 9, another embodiment of the RFID tag includes an integrated circuit 925 mounted above a substrate 950. The RFID tag is supported in one or more locations such that only a portion of the integrated circuit 925 is directly supported, and the remainder of the RFID tag is cantilevered. Under sufficient acceleration, this mechanical arrangement will fail. Under sufficient acceleration in a first direction, the integrated circuit material (e.g., silicon) will fail. In some cases, it may be necessary to create a back side etch 975 in a back side of the integrated circuit to provide a lower acceleration at which material failure occurs. So, by means of example, the forces and accelerations of an explosion create a shock wave, which moves in a predictable direction. By attaching the RFID tag to the bomb casing in such a way that the blast wave will compromise the integrated circuit material, the RFID tag will be rendered inoperative, even if the bomb fragment is large enough to contain the entire RFID tag, and even if the RFID tag is otherwise intact.

In some cases, it may be desirable to add an additional direction of failure, and FIG. 9 illustrates that if the supporting spacers (one of which is designated 990) between the integrated circuit 925 and the carrier are appropriately configured, the spacers 990 will fail, given sufficient acceleration in a second direction. Inasmuch as commonly used ceramic materials have much greater compression strength than shearing strength, and because ceramics are often used for integrated circuit carriers and other integrated circuit assemblies, ceramics are an illustrative embodiment of a material for a supporting spacer 990 with the characteristics shown. However, it is important to note that wide ranges of supporting spacer configurations are also within the broad scope of the present invention. For example, by techniques including backside thinning of the substrate 950, the supporting spacers 990 may be mechanically integral to the integrated circuit 925. Again, the RFID tag includes a non-electrical destruction mechanism (e.g., at least the integrated circuit 925 and the supporting spacer 990) coupled to the substrate and configured to render the RFID tag inoperative upon an occurrence of an event.

There are a wide number of applications that may benefit from the principles described herein including applications involving sensitive products, or applications wherein items or articles are exposed to excessive or undesirable environmental conditions such as pressure or excessive acceleration. Also, other methods to destroy the functional integrity of the RFID tag, and hence destroy or change the ability of the RFID tag to respond to the interrogator, are well within the broad scope of the present invention. Likewise, it is well within the broad scope of the present invention to incorporate methods and sensors to detect undesirable environments and apply the response of sensors in a manner to alter the circuit's response to an interrogator.

Turning now to FIG. 10, illustrated is block diagram of an embodiment of an RFID interrogation system constructed in accordance with the principles of the present invention. The RFID interrogation system includes a navigation system (e.g., a global positioning system (GPS) receiver) 1010 and an interrogator 1020 coupled to a synthetic aperture radar (SAR) processor 1030. The GPS receiver 1010, the interrogator 1020 and the SAR processor 1030 are located on a platform 1040, which is typically movable such as within an aircraft or vehicle. Those skilled in the art should understand that, for instance, the SAR processor 1030 may not be located on the platform 1040 and the processing therefrom may be not be performed in real time, potentially in conjunction with another computer system. In such cases, a memory of the RFID interrogation system logs the information for processing at a later time. The GPS receiver 1010 communicates with a constellation of satellites 1050 and the interrogator 1030 searches for RFID tags 1060. The interrogator 1020 receives responses from the RFID tag 1060 and the GPS receiver 1010 provides information about a time and positioning in response to the detection of an RFID tag 1060. The SAR processor 1030 employs the information from the GPS receiver 1010 and the interrogator 1020 and constructs a signal from a synthetic aperture derived from the responses from the RFID tag and the time and positioning information and acts like a high gain antenna array thereby increasing the gain and resolution associated with the RFID interrogation system.

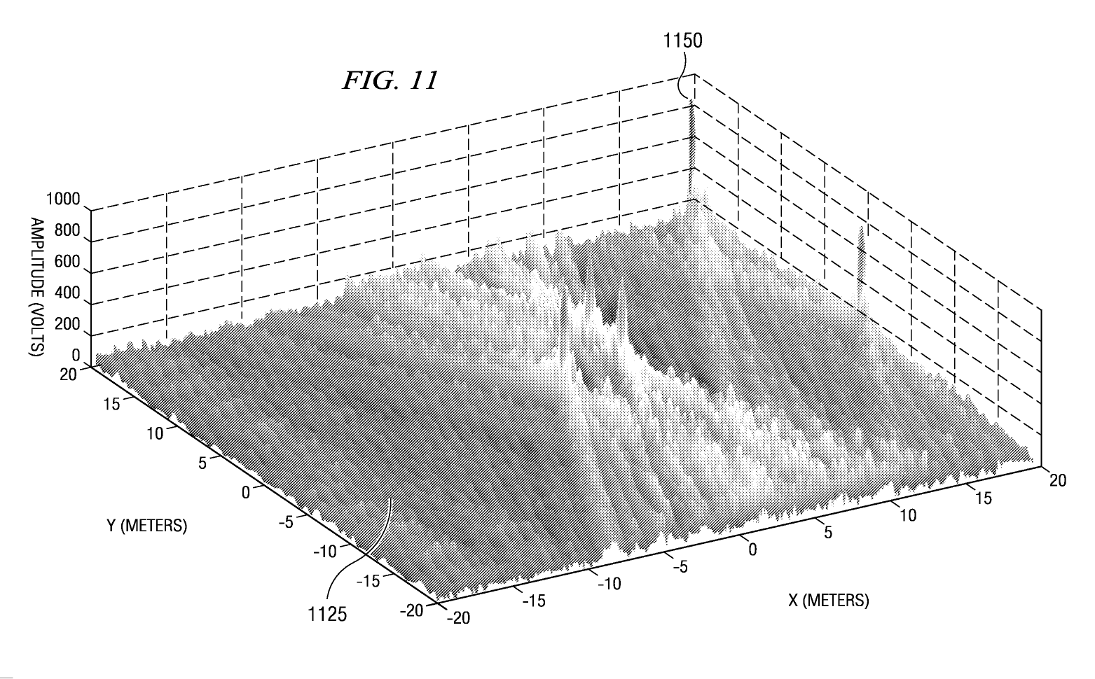

Turning now to FIG. 11, illustrated is a diagram demonstrating advantages associated with the embodiment of the RFID interrogation system of FIG. 10. Often it is important to not only detect a response from a query from the interrogator, but also to establish the location of the RFID object. A technique employable to detect a location thereof is to integrate SAR techniques and inverse synthetic aperture radar (ISAR) techniques with a correlating receiver of the interrogator. In order to do this, either the RFID object or the interrogator is in motion to simulate an antenna array. Detecting a position of the RFID tag, and time and position tagging of the received data can be achieved by the inclusion of the GPS receiver or other tracking system such as an inertial tracking system or other radio based systems into the RFID interrogation system. In either case, phase coherence should be maintained over a period of time, which is not an attribute of conventional interrogators.

The addition of phase coherence, and the coherent signal processing associated with some embodiments of the correlating receivers described herein allow the RFID tag to be used in a mode similar to that involved with SAR transponders, thereby permitting the RFID tag to act as a “transponder.” While conventional transponders do not operate like RFID tags, much of the signal processing theory taught in SAR/ISAR theory can be brought to bear, in addition to related signal processing methods. The illustrated embodiment demonstrates the detection of RFID tags employing SAR techniques. The two dimensional diagram demonstrates background noise (i.e., low level hash generally designated 1125) and the existence and location of five RFID tags (i.e., the five peaks of which one is designated 1150).

Often it is desirable not only to know about the existence of an RFID object by querying the RFID tag attached thereto, but also to know some additional information about the object itself. This information can be derived by sensors (e.g., sensor 860 illustrated with respect to FIG. 8) embedded as part of the RFID tag or as external inputs to the RFID tag. Examples of such sensors include, but are not limited to, temperature sensors and strain gauges and information such as maximum or minimum temperature achieved at some time in the past, a failure mode, or a state change may be obtained therefrom. The aforementioned information can often be reported as at least a single bit. The single bit can be reported by having the RFID tag respond with more than one reply code depending on whether or not that state change occurred.

For example, a response of one reply code would indicate that the state change did not occur and the response by that same RFID tag with a different reply code would indicate that the state change had, in fact, occurred. Then by increasing the number of possible responses from the RFID tag, multiple sensor states could be reported. Alternatively, a response from an RFID tag may alternate between at least two reply codes in sequence to report multiple state changes. In this manner, sophisticated monitoring of many RFID objects is possible without actually touching them or unpacking them from protective containers. The use of different reply codes permits the use of the powerful correlation techniques by the interrogator.

The use of embedded RFID tags has been put forth for applications such as strain gauges in composite materials, and for recording environmental history data, in particular for monitoring the storage environment for sensitive items such as warheads. By embedding the RFID tags with other sensors and employing correlating receivers, a number of desirable attributes may be achieved. Among these desirable attributes are the ability to operate the interrogator at lower power levels, which is a consideration for some processes in which the total energy input should be managed, such as explosives applications wherein power limitations may be much more severe than FCC Part 15 or similar limits, and processes such as biomedical research applications where interrogator power might influence a biological process.

Other applications of these improved attributes include the benefits of improved sensitivity from use of the correlation techniques taught herein. For example, in a large composite structure with a high percentage of carbon fiber, it is now possible to use a deeply embedded RFID tag with a strain gauge feature and an interrogator as described herein to overcome the attenuation caused by the composite material in the signal path. For disaster recovery teams, the RFID interrogation system allows RFID tags to be usefully embedded in structural elements of a vehicle, simplifying accident investigation after a crash or other such event. For unexploded ordinance clean up, the RFID interrogation system allows an RFID tag to tell UXO personnel the state of an item. For example, if such RFID tags were embedded in the case of a warhead, peak acceleration information could be used to infer whether the warhead had dudded, (i.e., had gone off “low order”) and therefore had scattered explosive materials, had burned out, or had gone off “high order” as designed. These are examples of the use of embedded RFID tags with multiple discreet states.

The correlation techniques described herein are compatible with carrier frequency diversity, a common method used for attempting to find the optimal propagation frequency for embedded RFID tags. Those skilled in the art will readily see that the invention taught herein has a wide range of applications; to enable the embedded use of sensors with RFID tags, to provide for a new class of embedded RFID sensors, and to extend the practical use of existing and proposed sensors with RFID tags.

Exemplary embodiments of the present invention have been illustrated with reference to specific electronic components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of applications to identify and detect RFID objects.

For a better understanding of communication theory and radio frequency identification communication systems, see the following references “RFID Handbook,” by Klaus Finkenzeller, published by John Wiley & Sons, Ltd., 2^{nd} edition (2003), “Technical Report 860 MHz-930 MHz Class I Radio Frequency Identification Tag Radio Frequency & Logical Communication Interface Specification Candidate Recommendation,” Version 1.0.1, November 2002, promulgated by the Auto-ID Center, Mass. Institute of Technology, 77 Massachusetts Avenue, Bldg 3-449, Cambridge Mass. 02139-4307, “Introduction to Spread Spectrum Communications,” by Roger L. Peterson, et al., Prentice Hall Inc. (1995), “Modern Communications and Spread Spectrum,” by George R. Cooper, et al., McGraw-Hill Book Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall Inc. (1996), “The Comprehensive Guide to Wireless Technologies,” by Lawrence Harte, et al, published by APDG Publishing (1998), “Introduction to Wireless Local Loop,” by William Webb, published by Artech Home Publishers (1998) and “The Mobile Communications Handbook,” by Jerry D. Gibson, published by CRC Press in cooperation with IEEE Press (1996). For a better understanding of conventional readers, see the following readers, namely, a “MP9320 UHF Long-Range Reader” provided by SAMSYS Technologies, Inc. of Ontario, Canada, a “MR-1824 Sentinel-Prox Medium Range Reader” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Washington and “ALR-9780 Reader,” provided by Alien Technology Corporation of Morgan Hill, Calif. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A radio frequency identification (RFID) tag, comprising:
a substrate having an electronic circuit and an antenna coupled thereto; and
a non-electrical destruction mechanism coupled to the substrate and configured to render said RFID tag inoperative upon an occurrence of an event.

2. The RFID tag as recited in claim 1 wherein said non-electrical destruction mechanism is configured to destroy an integrity of one of said electronic circuit and said antenna.

3. The RFID tag as recited in claim 1 wherein said non-electrical destruction mechanism comprises perforations in said substrate configured to tear said substrate to destroy an integrity of one of said electronic circuit and said antenna.

4. The RFID tag as recited in claim 1 wherein said non-electrical destruction mechanism comprises a lanyard attached to said substrate configured to tear said substrate to destroy an integrity of one of said electronic circuit and said antenna.

5. The RFID tag as recited in claim 1 wherein said non-electrical destruction mechanism comprises a pull tab attached to said substrate configured to destroy an integrity of one of said electronic circuit and said antenna by pulling said pull tab away from said substrate.

6. The RFID tag as recited in claim 1 wherein said non-electrical destruction mechanism comprises an environmentally sensitive component attached to said substrate.

7. The RFID tag as recited in claim 6 wherein said environmentally sensitive component is selected from the group consisting of:
a thermocouple,
a thermister,
an acoustic sensor,
a pressure sensor,
a light sensor, and
an acceleration sensor.

8. The RFID tag as recited in claim 1 wherein said non-electrical destruction mechanism comprises a chemical destruction mechanism.

9. The RFID tag as recited in claim 1 wherein said non-electrical destruction mechanism comprises a supporting spacer between said electronic circuit and said substrate configured to fail under acceleration to destroy an integrity of said electronic circuit.

10. The RFID tag as recited in claim 1 wherein said non-electrical destruction mechanism comprises a back side etch in said electronic circuit configured to cause a failure thereof.

11. A method of operating a radio frequency identification (RFID) tag, comprising:
providing a substrate having an electronic circuit and an antenna coupled thereto; and
rendering said RFID tag inoperative with a non-electrical destruction mechanism coupled to the substrate upon an occurrence of an event.

12. The method as recited in claim 11 wherein said rendering comprises destroying an integrity of one of said electronic circuit and said antenna.

13. The method as recited in claim 11 wherein said non-electrical destruction mechanism comprises perforations in said substrate and said rendering comprises tearing said substrate along said perforations to destroy an integrity of one of said electronic circuit and said antenna.

14. The method as recited in claim 11 wherein said non-electrical destruction mechanism comprises a lanyard attached to said substrate and said rendering comprises tearing said substrate with said lanyard to destroy an integrity of one of said electronic circuit and said antenna.

15. The method as recited in claim 11 wherein said non-electrical destruction mechanism comprises a pull tab attached to said substrate and said rendering comprises pulling said pull tab away from said substrate to destroy an integrity of one of said electronic circuit and said antenna.

16. The method as recited in claim 11 wherein said non-electrical destruction mechanism comprises an environmentally sensitive component attached to said substrate.

17. The method as recited in claim 16 wherein said environmentally sensitive component is selected from the group consisting of:
a thermocouple,
a thermister,
an acoustic sensor,
a pressure sensor,
a light sensor, and
an acceleration sensor.

18. The method tag as recited in claim 11 wherein said non-electrical destruction mechanism comprises a chemical destruction mechanism.

19. The method as recited in claim 11 wherein said non-electrical destruction mechanism comprises a supporting spacer between said electronic circuit and said substrate and said rendering comprises causing said supporting spacer to fail under acceleration to destroy an integrity of said electronic circuit.

20. The method as recited in claim 11 wherein said non-electrical destruction mechanism comprises a back side etch in said electronic circuit and said rendering comprises causing a failure of said electronic circuit in accordance with said back side etch.
